(19) United States
(12) Patent Application Publication
(10) Pub. No.: US 2021/0303347 A1
(43) Pub. Date: Sep. 30, 2021

(54) AUTOMATIC RESOURCE CONFIGURATION THROUGH WORKLOAD ANALYSIS

(71) Applicant: LENOVO ENTERPRISE SOLUTIONS (SINGAPORE) PTE. LTD., Singapore (SG)

(72) Inventors: ANDREW J. SLOMA, AUSTIN, TX (US); FRED A. BOWER, III, DURHAM, NC (US); DAVID B. ROBERTS, NEWCASTLE, ME (US); JOSEPH E. SANKAR, CARY, NC (US)

(21) Appl. No.: 16/835,873

(22) Filed: Mar. 31, 2020

(51) Int. Cl. G06F 9/50; G06F 11/34; H04L 12/24

(52) U.S. Cl. CPC G06F 9/505; G06F 9/5077; G06F 2201/81; H04L 41/0843; G06F 2209/5022; G06F 11/3414

(57) ABSTRACT

Automatic resource configuration through workload analysis includes maintaining a workload orchestrator database that, in turn, includes stable workload configurations and workload orchestrator stability policies; receiving a workload provisioning request including workload requirements; determining a stable configuration that matches at least part of the workload requirements; provisioning a compatible environment; and deploying the workload to the compatible environment.

### BACKGROUND

### Field of the Invention

The field of the present disclosure is workload orchestration, or, more specifically, methods, apparatus, and products for automatic resource configuration through workload analysis.

### Description of Related Art

Workloads in virtualized datacenters have configuration requirements for network, storage, and compute resources. Adding new instances of a workload requires additional configuration of these resources. Allocating and configuring the underlying hardware resources in a uniform way to support the workload can be error-prone. Additionally, a deep understanding of the available hardware resources, how they interact, and how they will perform is required.

Existing solutions require the administrator to have deep knowledge of the ecosystem in order to establish configuration patterns that can be applied to the various hardware resources for the workload to use. Alternatively, other implementations require an explicit connection be created between the management system running the workload and the management system to be running the new workload. In this implementation, the configuration of a master-slave relationship between management systems can be used to propagate configurations across the resources being used by the workload. Therefore, workload analysis that enables automatic resource configuration is desired.

### SUMMARY

Methods, systems, and apparatus for automatic resource configuration through workload analysis are disclosed in this specification. Methods, systems, and apparatus for automatic resource configuration through workload analysis comprising maintaining a workload orchestrator database including stable workload configurations and workload orchestrator stability policies; receiving a workload provisioning request including workload requirements; determining a stable configuration that matches at least part of the workload requirements; provisioning a compatible environment; and deploying the workload to the compatible environment.

The foregoing and other objects, features and advantages of the disclosure will be apparent from the following more particular descriptions of exemplary embodiments of the present disclosure as illustrated in the accompanying drawings wherein like reference numbers generally represent like parts of exemplary embodiments of the present disclosure.

### BRIEF DESCRIPTION OF THE DRAWINGS

FIG. 1 sets a block diagram of automated computing machinery including an example network system useful in automatic resource configuration through workload analysis according to embodiments of the present disclosure.

FIG. 2 sets a block diagram of automated computing machinery including an example computer useful in automatic resource configuration through workload analysis according to embodiments of the present disclosure.

FIG. 3 sets forth a flow chart illustrating an exemplary method for automatic resource configuration through workload analysis according to embodiments of the present disclosure.

FIG. 4 sets forth a flow chart illustrating an exemplary method for automatic resource configuration through workload analysis according to embodiments of the present disclosure.

### DETAILED DESCRIPTION

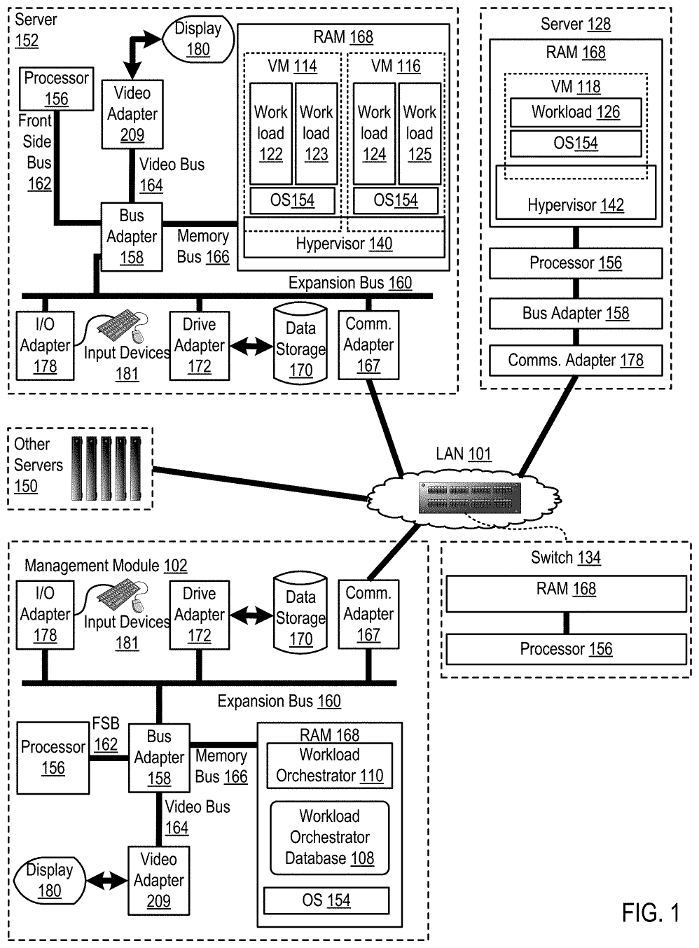

Exemplary methods, apparatus, and products for automatic resource configuration through workload analysis in accordance with the present invention are described with reference to the accompanying drawings, beginning with FIG. 1. FIG. 1 sets forth a line drawing of exemplary virtual machines managed among networked servers used for automatic resource configuration through workload analysis according to embodiments of the present invention.

A virtual machine (‘VM’), as the term is used in this specification, refers to a software implementation of a machine, such as a computer. A virtual machine enables sharing of the underlying physical machine resources between different virtual machines, each of which may run its own operating system. The software layer providing the virtualization is called a virtual machine monitor or hypervisor. A hypervisor is a module of automated computing machinery that performs software and hardware platform-virtualization in order to enable multiple operating systems to run on a host computer concurrently in separate virtual machines. A hypervisor runs directly on the host's hardware to control hardware access and to monitor guest operating-systems. A guest operating system runs on a level above the hypervisor. The platform virtualization provided by a hypervisor is referred to in this specification as a virtualized environment. A virtualized environment is one in which physical characteristics of a computing platform—computer processors, computer memory, I/O adapters, and the like—are abstracted from the perspective of an operating system and other software applications.

A server, as the term is used in this specification, refers generally to a multi-user computer that provides a service (e.g. database access, file transfer, remote access) or resources (e.g. file space) over a network connection. The term ‘server,’ as context requires, refers inclusively to the server's computer hardware as well as any server application software or operating system software running on the server. A server application is an application program that accepts connections in order to service requests from users by sending back responses. A server application can run on the same computer as the client application using it, or a server application can accept connections through a computer network. Examples of server applications include file server, database server, backup server, print server, mail server, web server, FTP servers, application servers, VPN servers, DHCP servers, DNS servers, WINS servers, logon servers, security servers, domain controllers, backup domain controllers, proxy servers, firewalls, and so on.

A workload, as the term is used in this specification, represents an amount of work to be performed by a particular computing device in a given period of time. Each VM in the virtualized environment may be assigned a particular workload based upon various specifications and requirements. Such a workload may include processing instructions, memory access instructions, data transfer instructions, and so on. The workload requirements may include, for example, information describing the nature of the workload (e.g., processing workload, memory access workload), information describing the amount of resources required to execute the workload, information describing the time constraints for completing execution of the workload, information describing security credentials required to execute the workload, and so on. Optimizing the workload distribution and resource configuration in a virtualization or container or cloud environment is known as orchestration.

In the example of FIG. 1, two of the servers are depicted in an expanded form for clarity of explanation: server (152) and server (128). Readers of skill in the art will understand, however, that each of the other servers (150) may include similar components to servers (152, 128) and operate in a similar fashion when participating in automatic resource configuration through workload analysis in accordance with embodiments of the present invention. Consider, as an example of server useful in systems in which automatic resource configuration through workload analysis is carried out in accordance with embodiments of the present invention, server (152). Server (152) includes at least one computer processor (156) or ‘CPU’ as well as random access memory (168) (RAM′) which is connected through a high speed memory bus (166) and bus adapter (158) to processor (156) and to other components of the server (152).

Stored in RAM (168) of the server (152) is a hypervisor (140) that enables two virtual machines (114, 116) to run on the server's (152) underlying hardware and utilize the server's (152) hardware resources. Executing within (or said another way, ‘running on’) virtual machine (114), is an operating system (154) and two workloads (122, 123). Operating systems useful in servers that participate in VM management according to embodiments of the present invention include UNIX™, Linux™, Microsoft XP™, AIX™, IBM's i5/OS™, and others as will occur to those of skill in the art. Executing within virtual machine (116) is an operating system (154) and two workloads (124, 125). Operating system (154) executing within virtual machine (116) may be a separate instance of the same operating system (154) executing in virtual machine (114), or may be another type of operating system (154) altogether. That is, both operating systems in server (152) may be the same—such as Unix™—or both operating systems may be different—such as Unix™ and Microsoft XP™.

The hypervisor (140), operating systems (154), and workloads (122-125) in the example of FIG. 1 are shown in RANI (168), but many components of such software typically are stored in non-volatile memory also, such as, for example, on a disk drive (170).

The server (152) of FIG. 1 includes disk drive adapter (172) coupled through expansion bus (160) and bus adapter (158) to processor (156) and other components of the server (152). Disk drive adapter (172) connects non-volatile data storage to the server (152) in the form of disk drive (170). Disk drive adapters useful in servers that participate in automatic resource configuration through workload analysis according to embodiments of the present invention include Integrated Drive Electronics (IDE′) adapters, Small Computer System Interface (SCSI′) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example server (152) of FIG. 1 includes one or more input/output (′I/O′) adapters (178). I/O adapters implement user-oriented input/output through, for example, software drivers and computer hardware for controlling output to display devices such as computer display screens, as well as user input from user input devices (181) such as keyboards and mice. The example server (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary server (152) of FIG. 1 includes a communications adapter (167) for data communications with other computers and for data communications with a data communications network (not shown in FIG. 1). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in servers that participate in automatic resource configuration through workload analysis according to embodiments of the present invention include modems for wired dial-up communications, Ethernet (IEEE 802.3) adapters for wired data communications network communications, and 802.11 adapters for wireless data communications network communications.

Although only server (152) is depicted as including a processor (156), RAM (168), bus adapter (158), communications adapter (167) and the like, readers of skill in the art will recognize that any of the other servers (150) in the example of FIG. 1 and, more specifically, server (128), may also include similar components. In the example of FIG. 1, server (128) is depicted as executing a hypervisor (142) that supports a virtual machine (118) within which an operating system (154) and a workload (126) are executing.

The switch (134) of FIG. 1 is an example of a network device, a unit that mediates data in a computer network. The switch (134) in the example of FIG. 1, couples the servers (150 and 152 and 128) for data communications with one another and with the management module (102) (‘MM’). The switch (134), in concert with the virtual machine management module (102) as described below, operates for automatic resource configuration through workload analysis in accordance with embodiments of the present invention.

The MM (102) of FIG. 1 is a management module of automated computing machinery comprising an aggregation of computer hardware and software that is configured to manage VMs among the networked servers (108 including 152 and 128) in the example of FIG. 1. The MM (102) in the example of FIG. 1 is executing a workload orchestrator (110), a module of computer program instructions that, in connection with a workload orchestrator database (108), when executed causes the MM (102) to operate for automatic resource configuration through workload analysis in accordance with embodiments of the present invention.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1. For example, automatic resource configuration through workload analysis may be implemented in a container or cloud network system.

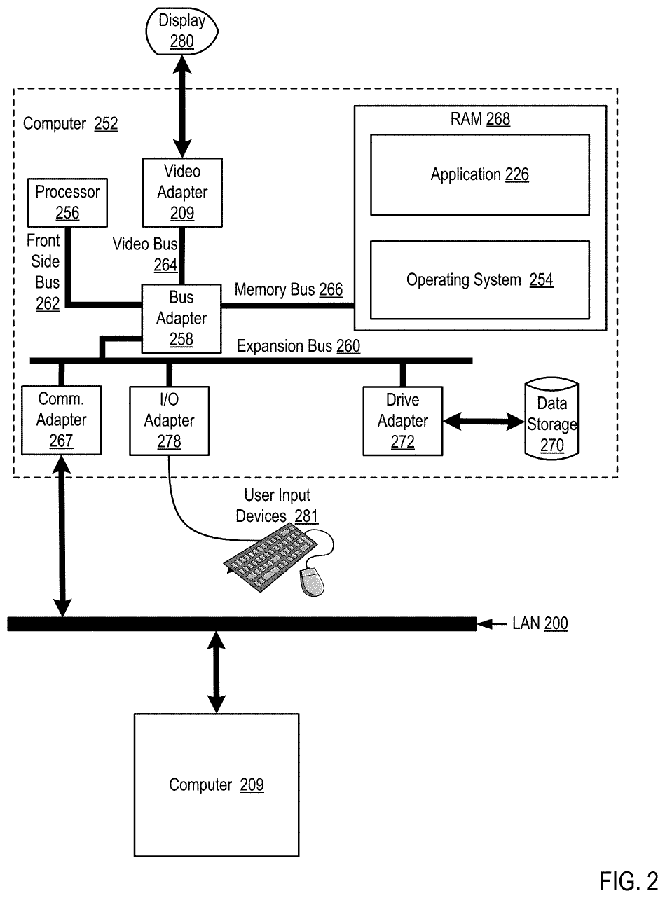

For further explanation, therefore, FIG. 2 sets forth a block diagram of automated computing machinery comprising an example computer (252) useful in automatic resource configuration through workload analysis according to embodiments of the present invention.

The computer (252) of FIG. 2 includes at least one computer processor (256) or ‘CPU’ as well as random access memory (268) (RAM′) which in this example is connected through a high speed memory bus (266) and bus adapter (258) to processor (256) and to other components of the computer (252). Stored in RAM (268) is an application (226), a module of computer program instructions useful in automatic resource configuration through workload analysis according to embodiments of the present invention.

The application (226) depicted in FIG. 2 may be configured for use in automatic resource configuration through workload analysis by: maintaining a workload orchestrator database including stable workload configurations and workload orchestrator stability policies; receiving a workload provisioning request including workload requirements; determining a stable configuration that matches at least part of the workload requirements; provisioning a compatible environment; and deploying the workload to the compatible environment, as explained in greater detail below.

Also stored in RAM (268) is an operating system (254). Operating systems useful in automatic resource configuration through workload analysis according to embodiments of the present invention include UNIX″, Linux, Microsoft operating systems, Apple iOS, Android operating systems, and others as will occur to those of skill in the art. The operating system (254) and the application (226) in the example of FIG. 2 are shown in RAM (268), but many components of such software typically are stored in non-volatile memory also, such as, for example, on a disk drive (270), in a solid-state drive (‘SSD’), and so on.

The computer (252) of FIG. 2 includes disk drive adapter (272) coupled through expansion bus (260) and bus adapter (258) to processor (256) and other components of the computer (252). Disk drive adapter (272) connects non-volatile data storage to the computer (252) in the form of disk drive (270). Disk drive adapters useful in computers for automatic resource configuration through workload analysis according to embodiments of the present invention include Integrated Drive Electronics (‘IDE’) adapters, Small Computer System Interface (SCSI′) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (252) of FIG. 2 includes one or more input/output (I/O′) adapters (278). I/O adapters implement user-oriented input/output through, for example, software drivers and computer hardware for controlling output to display devices such as computer display screens, as well as user input from user input devices (281) such as a touchscreen display, a keypad, an attached keyboard, and so on. The example computer (252) of FIG. 2 includes a video adapter (209), which is an example of an I/O adapter specially designed for graphic output to a display device (280) such as a touchscreen display screen. Video adapter (209) is connected to processor (256) through a high speed video bus (264), bus adapter (258), and the front side bus (262), which is also a high speed bus.

The example computer (252) of FIG. 2 includes a communications adapter (267) for data communications with other computers (282) and for data communications with a data communications network (200). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for automatic resource configuration through workload analysis according to embodiments of the present invention include, 802.11 adapters for wireless data communications network communications, adapters for communicating with telecommunications networks such as a Long-Term Evolution (‘LTE’) network, and so on.

The workload orchestrator (168) of FIG. 1 analyzes workload performance over time in order to assert the workload stability and its role as a reference configuration for future workload deployments, i.e., the workload orchestrator (168) tracks workload stability and determines stable reference configurations for workloads. The phrase ‘workload stability’ as used here refers to the specific stable hardware configuration running the workload without requiring maintenance, updating, or servicing for a period of time. The workload orchestrator (168) tracks workloads and the workloads' configurations in the workload orchestrator database (108) over time. The workload orchestrator (168) could include stability policies such as a stability threshold. A predefined policy may be created to analyze if a server that is a workload has not required maintenance or configuration over a period of time, for example, 2 weeks or 2 months. If the server meets the stability threshold, then the workload configuration can be designated to be stable and can be used as a reference configuration. Other user-defined policies may be created to determine the rules for determining a stable configuration. The workload's hardware configuration, including network, storage, boot settings, and firmware levels may be retrieved by management software such as a baseboard management controller (BMC) and stored by the workload orchestrator (168) in the workload orchestrator database (108) as a known stable configuration. The workload orchestrator (168) may also track workloads that have been running for a shorter amount of time as pending or potentially stable.

During subsequent provisioning of workloads, the workload orchestrator (168) may search for known stable configurations that match the new workload, partially or fully. The stable configuration may be auto-configured or may be used as a template to ensure that the new workload does not deviate from the stable configuration.

For example, a stable workload configuration may include a 25Gb 2-Port Ethernet Adapter with the switch configured to route port 1 traffic on vlan 1 and port 2 traffic on vlan 2. The workload orchestrator (168) may auto-provision this configuration from a pool of servers when tasked to deploy the same or a similar workload, select an existing server with the configuration, or indicate that a similar hardware configuration cannot be acquired. Alternatively, the workload orchestrator (168) may present the stable configuration as part of the workload provisioning by the administrator to ensure consistency with the stable configuration.

Additionally, a workload may be only a partial match for a stable configuration. In the example above, a new workload may be a workload that does not require the Ethernet configuration but may still benefit from the known stable configuration, i.e., the stable configuration may include additional hardware features that are not required for the workload. By contrast, a workload could be only a partial match for a stable configuration if an older or newer firmware version is used than is specified in the stable configuration. When a stable configuration is only a partial match, then the workload may be provisioned with an indication of a partial stable configuration match.

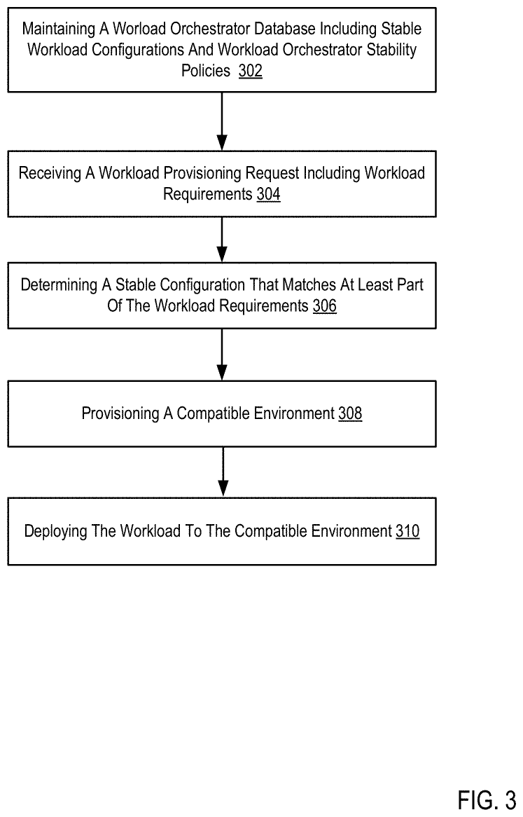

For further explanation, FIG. 3 sets forth a flow chart illustrating an exemplary method for automatic resource configuration through workload analysis according to embodiments of the present disclosure. The method of FIG. 3 includes maintaining (302) a workload orchestrator database including stable workload configurations and workload orchestrator stability policies. Maintaining (302) a workload orchestrator database including stable workload configurations and workload orchestrator stability policies includes maintaining both stable workload configurations and workload configurations that are pending and have not been running long enough to be considered stable. As described above, the workload orchestrator database can follow workload orchestrator stability policies that are predefined and workload orchestrator stability policies that are defined by a user. The workload orchestrator stability policies can include a stability threshold, for example, 2 weeks or 2 months of no maintenance or configuration.

FIG. 3 also includes receiving (304) a workload provisioning request including workload requirements. The workload requirements can specify hardware requirements including network, storage, boot settings, and firmware levels. The workload requirements can specify some required hardware features or all of the hardware requirements. The workload provisioning request may be received by the management module (102) from an automated workload request or from a workload administrator. More specifically, the workload provisioning request may be received by the management module (102) as a prefilled template, uploaded from a workload administrator, as a copy of an existing configured workload, imported from another local or remote workload management system, or from a blank VM with components installed manually. For already-provisioned workloads, there are systems where additional load causes automatic deployment of additional workload to handle the load on demand. This may occur in service-based architectures where services see variable demand over time. In these types of systems, the workload may come from an automated element of the workload orchestrator (110).

FIG. 3 also includes determining (306) a stable configuration that matches at least part of the workload requirements. As described above, a stable configuration that matches the workload requirements completely may be selected or a stable configuration that matches part of the workload requirements may be selected. Determining (306) that a stable configuration matches at least part of the workload requirements may be carried out in a variety of manners. In some embodiments, determining that a stable configuration matches at least part of the workload requirements includes comparing, by the workload orchestrator (110), the workload requirements to stable configurations stored in the workload orchestrator database (108). Determining (306) that a stable configuration matches at least part of the workload requirements may be carried out by comparing, by the workload orchestrator (110), metadata associated with the workload received as part of the creation or instantiation of the workload, by analysis of the workload to derive the metadata automatically, by association to a base workload profile or template for workloads that are copied from a template, or via the use of analysis to derive an abstract profile using machine learning techniques such as a trained model using inference over the workload in a provisional environment before it is deployed into production.

FIG. 3 also includes provisioning (308) a compatible environment. Provisioning (308) a compatible environment may include selecting an existing hardware configuration or configuring hardware in order to match the stable configuration by the workload orchestrator (110). The compatible environment may be a stable configuration that provides stability for the workload or may be a configuration that is optimized for the use of hardware resources for the workload and the network system.

FIG. 3 also includes deploying (310) the workload to the compatible environment. Deploying (310) the workload includes installing or activating the workload by the workload orchestrator (110). Alternatively, the workload may be deployed by the workload administrator or by a customer. More specifically, the server (150) where the workload is coming from is connected to the host server (152, 128) that will execute it and then it is started. There may be a transfer of data to a more local storage location as part of this process as well as additional orchestration/initialization of the hardware by the workload orchestrator (110) based upon the workload requirements and the orchestration framework operation semantics.

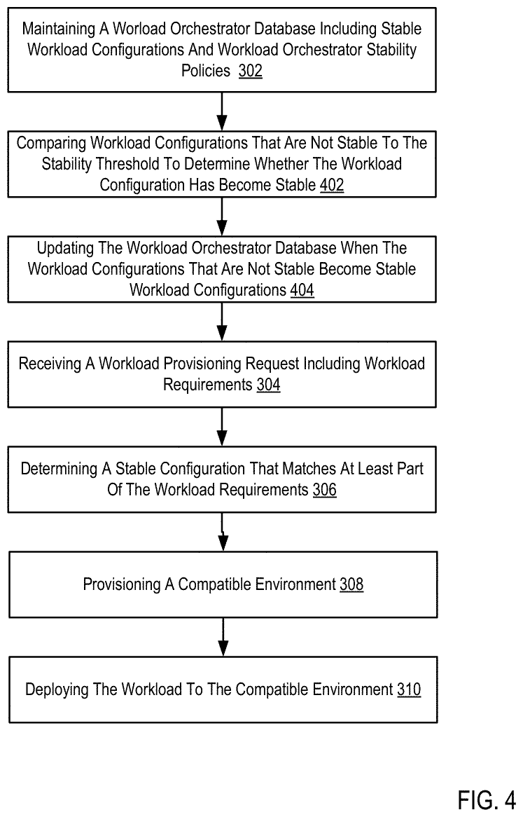

For further explanation, FIG. 4 sets forth a flow chart illustrating an exemplary method for automatic resource configuration through workload analysis according to embodiments of the present disclosure that includes maintaining (302) a workload orchestrator database including stable workload configurations and workload orchestrator stability policies; receiving (304) a workload provisioning request including workload requirements; determining (306) a stable configuration that matches at least part of the workload requirements; provisioning (308) a compatible environment; and deploying (310) the workload to the compatible environment.

The method of FIG. 4 differs from the method of FIG. 3, however, and further includes comparing (402) workload configurations that are not stable to the stability threshold to determine whether the workload configuration has become stable. The comparison may be made by the workload orchestrator (110) comparing workload configurations that are not stable that are stored in the workload orchestrator database (108) to the stability threshold. As described above, the stability threshold can be a predefined stability threshold that may be created to determine if a server that is part of a workload configuration has not required maintenance or configuration over a period of time, for example, 2 weeks or 2 months. The workload orchestrator (168) may track workloads that have been running for a shorter amount of time as well as workloads that have received maintenance and that are not designated as stable. The workload's hardware configuration, including network, storage, boot settings, and firmware levels may be retrieved by management software such as a baseboard management controller (BMC) and stored by the workload orchestrator (168) in the workload orchestrator database (108) as a workload configuration that is not stable.

The method of FIG. 4 differs from the method of FIG. 3, however, and further includes updating (404) the workload orchestrator database when the workload configurations that are not stable become stable workload configurations. The workload orchestrator (110) may update the workload orchestrator database (108). Each workload configuration may include a designation of stable or not stable. If the server meets the stability threshold, then the workload configuration can be designated to be stable in the workload orchestrator database (108). The designation of the existing workload configuration may be updated in the workload orchestrator database (108), or the workload's hardware configuration, including network, storage, boot settings, and firmware levels may be retrieved by management software such as a baseboard management controller (BMC) and stored by the workload orchestrator (168) in the workload orchestrator database (108) as a known stable configuration.

In view of the explanations set forth above, readers will recognize that the benefits of automatic resource configuration through workload analysis according to embodiments of the present disclosure include:

Improved workload configuration stability.

Automatic workload provisioning.

Exemplary embodiments of the present disclosure are described largely in the context of a fully functional computer system for automatic resource configuration through workload analysis. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. An apparatus comprising a computing device, a computer processor, and a computer memory operatively coupled to the computer processor, the computer memory storing computer program instructions that are configured to, when executed by the computer processor, cause the apparatus to perform operations comprising:
maintaining a workload orchestrator database including stable workload configurations and workload orchestrator stability policies;
receiving a workload provisioning request including workload requirements;
determining a stable configuration that matches at least part of the workload requirements;
provisioning a compatible environment; and
deploying the workload to the compatible environment.

2. The apparatus of claim 1, wherein the workload orchestrator database includes both the stable workload configurations and workload configurations that are not stable.

3. The apparatus of claim 1, wherein the workload orchestrator stability policies include a stability threshold.

4. The apparatus of claim 3, wherein the stability threshold is a predefined period of time where a server in the workload configuration has not required maintenance.

5. The apparatus of claim 3, further comprising:
comparing workload configurations that are not stable to the stability threshold to determine whether the workload configuration has become stable; and
updating the workload orchestrator database when the workload configurations that are not stable become stable workload configurations.

6. The apparatus of claim 1, wherein provisioning a compatible environment includes using the stable configuration as a template.

7. The apparatus of claim 1, wherein provisioning a compatible environment includes automatically configuring required features according to the workload requirements and the stable configuration.

8. A computer program product comprising a computer readable medium and computer program instructions stored therein that are configured to, when executed by a processor, cause a computer to perform operations comprising:
maintaining a workload orchestrator database including stable workload configurations and workload orchestrator stability policies;
receiving a workload provisioning request including workload requirements;
determining a stable configuration that matches at least part of the workload requirements;
provisioning a compatible environment; and
deploying the workload to the compatible environment.

9. The computer program product of claim 8, wherein the workload orchestrator database includes both the stable workload configurations and workload configurations that are not stable.

10. The computer program product of claim 8, wherein the workload orchestrator stability policies include a stability threshold.

11. The computer program product of claim 10, wherein the stability threshold is a predefined period of time where a server in the workload configuration has not required maintenance.

12. The computer program product of claim 10, further comprising:
comparing workload configurations that are not stable to the stability threshold to determine whether the workload configuration has become stable; and
updating the workload orchestrator database when the workload configurations that are not stable become stable workload configurations.

13. The computer program product of claim 8, wherein provisioning a compatible environment includes using the stable configuration as a template.

14. The computer program product of claim 8, wherein provisioning a compatible environment includes automatically configuring required features according to the workload requirements and the stable configuration.

15. A method comprising:
by program instructions on a computing device,
maintaining a workload orchestrator database including stable workload configurations and workload orchestrator stability policies;
receiving a workload provisioning request including workload requirements;
determining a stable configuration that matches at least part of the workload requirements;
provisioning a compatible environment; and
deploying the workload to the compatible environment.

16. The method of claim 15, wherein the workload orchestrator database includes both the stable workload configurations and workload configurations that are not stable.

17. The method of claim 15, wherein the workload orchestrator stability policies include a stability threshold.

18. The method of claim 17, wherein the stability threshold is a predefined period of time where a server in the workload configuration has not required maintenance.

19. The method of claim 17, further comprising:
comparing workload configurations that are not stable to the stability threshold to determine whether the workload configuration has become stable; and
updating the workload orchestrator database when the workload configurations that are not stable become stable workload configurations.

20. The method of claim 15, wherein provisioning a compatible environment includes automatically configuring required features according to the workload requirements and the stable configuration.
